(19) United States
(12) Patent Application Publication
(10) Pub. No.: US 2023/0229765 A1
(43) Pub. Date: Jul. 20, 2023

(54) INTELLIGENT DISTRIBUTED CYBERSECURITY AGENT

(71) Applicant: OREV Secured Networks LLC, Boca Raton, FL (US)

(72) Inventors: Gabi Saadon, Ashdod (IL); Shmuel Silverman, Novato, CA (US)

(21) Appl. No.: 18/154,594

(22) Filed: Jan. 13, 2023

Related U.S. Application Data
(60) Provisional application No. 63/299,784, filed on Jan. 14, 2022.

(51) Int. Cl. G06F 21/55; G06F 21/45

(52) U.S. Cl. CPC G06F 21/554; G06F 21/45; G06F 2221/034

(57) ABSTRACT

During operation, an electronic device may receive user information associated with a user. Then, the electronic device may provide, to a computer system, the user information. Moreover, the electronic device may receive, from the computer system, a pretrained predictive model associated with the user. Furthermore, the electronic device may monitor activity associated with an event while the user uses the electronic device, where the activity includes a hardware activity and/or a software activity. Next, the electronic device may analyze the activity using the pretrained predictive model to identify the event, and may provide, to the computer system, event information specifying a process, which is associated with the event. Additionally, the electronic device may receive, from the computer system, severity information that indicates a security risk associated with the event. Based at least in part on the severity information, the electronic device may selectively perform a remedial action.

### CROSS REFERENCE TO RELATED APPLICATIONS

This application claims priority under 35 U.S.C. 119(e) to: U.S. Provisional Application Serial No. 63/299,784, “Intelligent Distributed Cybersecurity Agent,” by Gabi Saadon et al., filed on Jan. 14, 2022, the contents of which are herein incorporated by reference.

### FIELD

The described embodiments relate, generally, to security techniques for detecting anomalous behaviors of host-computer hardware and software.

### BACKGROUND

The hardware and software infrastructure of a typical enterprise is becoming increasingly complicated. This hardware and software infrastructure may include several internal networks, remote offices with their own local infrastructure, remote and/or mobile electronic devices associated with individuals, and/or cloud services. The complexity of the hardware and the software infrastructure often outstrips traditional techniques for perimeter-based network security, because there is no longer a single, easily identified perimeter for the enterprise.

Presently, it takes companies, on average, about 197 days to identify a network-security attack and 69 days to contain the associated breach. The amount of time it takes to detect a breach varies by industry, with entertainment and health care taking upwards of 250 days. There are multiple factors that can impact the data-breach-response time, including: preparation, technology and privacy laws.

There are several existing security techniques for detecting suspicious or malicious activity within a network and associated tools include: an Intrusion Detection System, an Intrusion Prevention System, Data Loss Prevention, Security Incident and Event Management, and Network Behavior Anomaly Detection. Additionally, a company usually installs antivirus or other cybersecurity program on electronic devices associated with the company, including on-site and remote electronic devices. In some cases, users may install two different types of antivirus software for greater protection. However, these anti-virus solutions can only detect known viruses (e.g., based on known signatures of the viruses).

Another existing security technique is based on the use of detection logs through malware protection and detection hardware and/or software with logging capabilities. For example, software agents may read a log of events that are occurring in a computer system. Then, this information may be sent to a network security system and/or a cybersecurity professional for analysis in order to identify any unusual activity. However, there is often a lot of data to analyze. Consequently, the analysis is typically time-consuming and expensive. Moreover, managing the massive amount of data that is collected on an ongoing basis is usually unsustainable. Therefore, it is easy to lose and/or misinterpret information and, thus, to miss potential security threats.

The increasing proliferation of network-security attacks and the limitations of existing security techniques are an increasing problem for companies and have adverse consequences for business activity.

### SUMMARY

An electronic device is described. This electronic device includes: an interface circuit that communicates with a computer system; a computation device; and memory that stores program instructions, where, when executed by the computation device, the program instructions cause the electronic device to perform operations. During operation, the electronic device receives user information associated with a user of the electronic device. Then, the electronic device provides, addressed to the computer system, the user information. Moreover, the electronic device receives, associated with the computer system, a pretrained predictive model associated with the user. Furthermore, the electronic device monitors activity associated with an event while the user uses the electronic device, where the activity includes a hardware activity and/or a software activity. Next, the electronic device analyzes the activity using the pretrained predictive model to identify the event, and provides, addressed to the computer system, event information specifying a process, which is associated with the event. Additionally, the electronic device receives, associated with the computer system, severity information that indicates a security risk associated with the event. Based at least in part on the severity information, the electronic device selectively performs a remedial action.

Note that the user information may include login information.

Moreover, the activity may be associated with or may include: a hardware change, a software change, a memory operation, a type of file accessed, a location of the file, a failed login attempt, user-interface activity, an executed application, and/or communication with another electronic device.

Furthermore, the pretrained predictive model may include a neural network.

Additionally, the pretrained predictive model may be associated with multiple electronic devices previously used by the user. In some embodiments, the multiple electronic devices may include the electronic device.

Note that the pretrained predictive model may be associated with different types of activities or personas of the user.

Moreover, the pretrained predictive model may be based at least in part on historical behavior of the user.

Furthermore, the remedial action may include discontinuing the process associated with the event.

Additionally, the remedial action may include changing an alert level for the user, where the alert level corresponds to a deviation from expected behavior of the user.

In some embodiments, the monitoring, the analysis, the providing of the event information, the receiving of the severity information, and the selective performing of the remedial action may occur in real-time as the electronic device performs the process associated with the event.

Note that, when the severity information indicates that the remedial action is not needed or that retraining is needed, the operations may include updating the pretrained predictive model based at least in part on the event and the severity information.

Moreover, when the severity information indicates that the remedial action is not needed, the operations may include providing, addressed to the computer system, feedback information for use in updating the pretrained predictive model, where the feedback information includes the event information and the severity information. In some embodiments, the feedback information may be provided after a current session of the user on the electronic device ends.

Furthermore, the event may not have been previously identified by the pretrained predictive model for the user.

Other embodiments provide a computer system, which perform counterpart operations to at least some of the aforementioned operations of the electronic device.

Other embodiments provide a computer-readable storage medium for use with the electronic device or the computer system. When program instructions stored in the computer-readable storage medium are executed by the electronic device or the computer system, the program instructions may cause the electronic device or the computer system to perform at least some of the aforementioned operations of the electronic device or counterpart operations to the aforementioned operations.

Other embodiments provide a method. The method includes at least some of the aforementioned operations performed by the electronic device, or counterpart operations to the aforementioned operations, which are performed by the computer system.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an example of communication between electronic devices according to some embodiments of the disclosure.

FIG. 2 is a flow diagram illustrating an example of a method for selectively performing a remedial action using an electronic device in FIG. 1 in accordance with an embodiment of the present disclosure.

FIG. 3 is a drawing illustrating an example of communication among an electronic device and a computer system in FIG. 1 in accordance with an embodiment of the present disclosure.

FIG. 4 is a drawing illustrating an example of genotype-to-phenotype mapping in accordance with an embodiment of the present disclosure.

FIG. 5 is a drawing illustrating an example of two types of structural mutation in accordance with an embodiment of the present disclosure.

FIG. 6 is a drawing illustrating an example of matching up genomes for different network topologies using innovation numbers in accordance with an embodiment of the present disclosure.

FIG. 7 is a flow diagram illustrating an example of a method for evolving a neuroevolution (NE) object of a user using an electronic device in FIG. 1 in accordance with an embodiment of the present disclosure.

FIG. 8 is a drawing illustrating an example of monitoring of normal behavioral ranges of a user using an agent in accordance with an embodiment of the present disclosure.

FIG. 9 is a drawing illustrating an example of communication among an electronic device associated with a user, a client or an agent, and a computer system in FIG. 1 in accordance with an embodiment of the present disclosure.

FIG. 10 is a drawing illustrating an example of communication among an electronic device associated with a user, a client or an agent, and a computer system in FIG. 1 in accordance with an embodiment of the present disclosure.

FIG. 11 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

During operation, an electronic device may receive user information associated with a user of the electronic device. Then, the electronic device may provide, addressed to the computer system, the user information. Moreover, the electronic device may receive, associated with the computer system, a pretrained predictive model associated with the user. Furthermore, the electronic device may monitor activity associated with an event while the user uses the electronic device, where the activity includes a hardware activity and/or a software activity. Next, the electronic device may analyze the activity using the pretrained predictive model to identify the event, and may provide, addressed to the computer system, event information specifying a process, which is associated with the event. Additionally, the electronic device may receive, associated with the computer system, severity information that indicates a security risk associated with the event. Based at least in part on the severity information, the electronic device may selectively perform a remedial action.

By performing, at least in part, user-specific identification, these security (or cybersecurity) techniques may more rapidly and accurately detect intrusions and malicious events in a computer system. These capabilities may enable effective and timely remedial action with reduced or eliminated false-positive detections, thereby reducing or eliminating the security risk and harm associated with the intrusions and malicious events. Moreover, the security techniques may readily scale to large computer systems in a cost-effective and less-complicated manner. Consequently, the security techniques may improve security, may improve user satisfaction and may enhance business activity and trust.

In the discussion that follows, electronic devices, computers and/or servers (which may be local or remotely located from each other) may communicate packets or frames in accordance with a wired communication protocol and/or a wireless communication protocol. The wireless communication protocol may include: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Texas), Bluetooth, Bluetooth low energy, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, the wired communication protocol may include a wired communication protocol that is compatible with an IEEE 802.3 standard (which is sometimes referred to as ‘Ethernet’), e.g., an Ethernet II standard. However, a wide variety of communication protocols may be used. In the discussion that follows, Wi-Fi and Ethernet are used as illustrative examples.

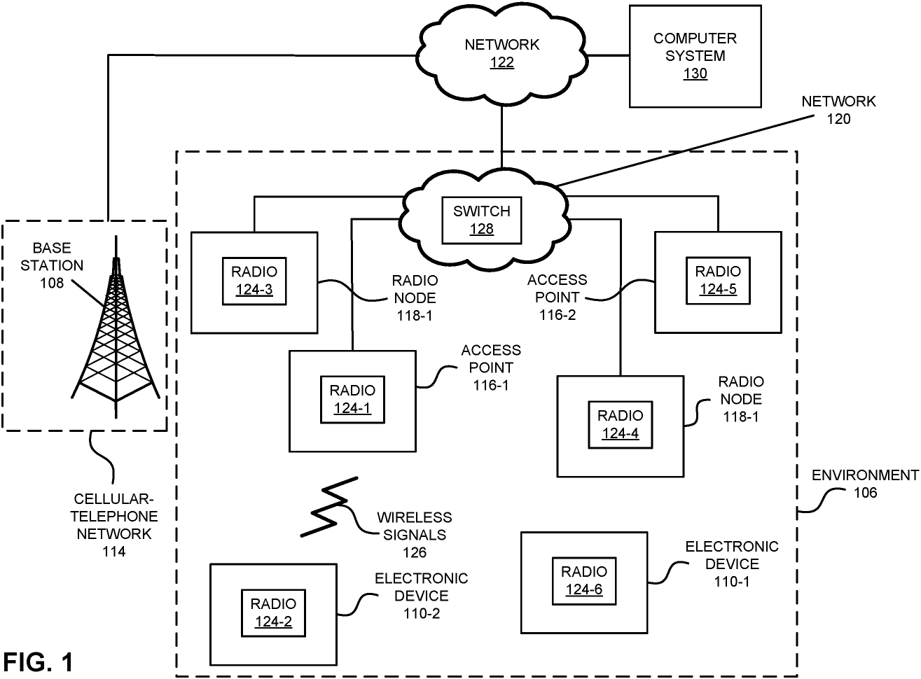

We now describe some embodiments of the security techniques. FIG. 1 presents a block diagram illustrating an example of communication between electronic devices 110 (such as a cellular telephone, a portable electronic device, or another type of electronic device, etc.) in an environment 106. Moreover, electronic devices 110 may optionally communicate via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 110 may optionally communicate with computer system 130 (which may include one or more computers or servers, and which may be implemented locally or remotely to provide storage and/or analysis services) using a wired communication protocol (such as Ethernet) via network 120 and/or 122. Note that networks 120 and 122 may be the same or different networks. For example, networks 120 and/or 122 may be a LAN, an intranet or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

Electronic devices 110 and/or computer system 130 may implement at least some of the operations in the security techniques. Notably, as described further below, a given one of electronic devices (such as electronic device 110-1) and/or computer system 130 may perform at least some of the analysis of data associated with electronic device 110-1 (such as first detection of a new peripheral, communication via an interface, a change to software or program instructions, a change to a DLL, a change to stored information, etc.) acquired by an agent executing in an environment (such as an operating system) of electronic device 110-1, and may provide data and/or first-detection information to computer system 130.

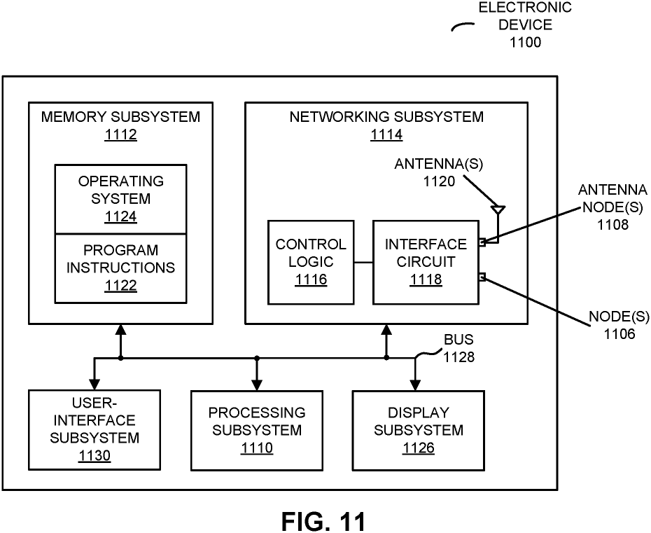

As described further below with reference to FIG. 11, base station 108, electronic devices 110, access points 116, radio node 118, switch 128 and/or computer system 130 may include subsystems, such as a networking subsystem, a memory subsystem and a processor subsystem. In addition, electronic devices 110, access points 116 and radio node 118 may include radios 124 in the networking subsystems. More generally, electronic devices 110, access points 116 and radio node 118 can include (or can be included within) any electronic devices with the networking subsystems that enable electronic devices 110, access points 116 and radio node 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, base station 108, electronic devices 110, access points 116, radio node 118 and/or computer system 130 may wired or wirelessly communicate while: transmitting access requests and receiving access responses on wired or wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and electronic devices 110. For example, radio 124-1 in access point 116-1 may transmit information (such as one or more packets or frames) using wireless signals 126. These wireless signals are received by radio 124-2 in electronic device 110-1. This may allow access point 116-1 to communicate information to other access points 116 and/or electronic devices 110. Note that wireless signals 126 may convey one or more packets or frames.

In the described embodiments, processing a packet or a frame in one or more electronic devices in electronic devices 110, access points 116, radio node 118 and/or computer system 130 may include: receiving the wireless or electrical signals with the packet or the frame; decoding/extracting the packet or the frame from the received wireless or electrical signals to acquire the packet or the frame; and processing the packet or the frame to determine information contained in the payload of the packet or the frame.

Note that the wired and/or wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multiuser transmission (such as orthogonal frequency division multiple access or OFDMA) and/or multiple input multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

While FIG. 1 illustrates computer system 130 at a particular location, in other embodiments at least a portion of computer system 130 is implemented at more than one location. Thus, in some embodiments, computer system 130 is implemented in a centralized manner, while in other embodiments at least a portion of computer system 130 is implemented in a distributed manner.

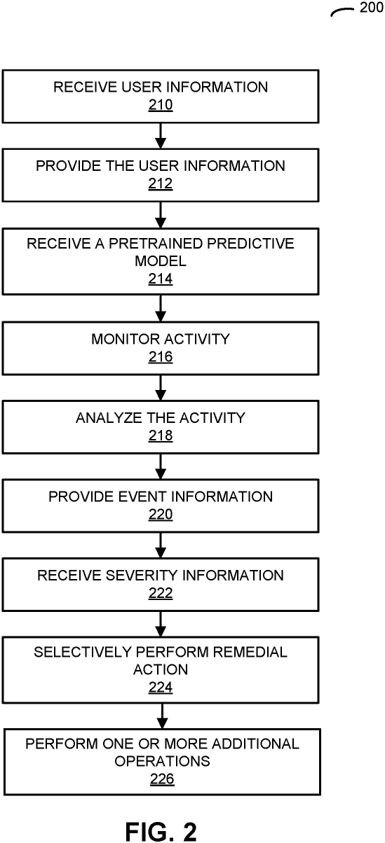

As discussed previously, detecting intrusion and/or malicious events in a computer system or a network is often difficult. Moreover, as described further below with reference to FIGS. 2-10, in order to address these challenges, electronic devices 110 and/or computer system 130 may perform the security techniques. Notably, agents executing in environments (such as operating systems) of electronic devices 110 may monitor and/or detect access attempts via a port (e.g., via a USB interface or another communication interface), software changes (e.g., to an operating system, a DLL, etc.), changes to stored information, first detection of a new electronic device, etc.

In some embodiments, analysis of the monitored information may be performed by a given agent executing on, e.g., electronic device 110-1 (such as to detect the changes and/or in order to perform the first detection). Next, the given agent may provide a notification of the detected changes and/or the first detection to computer system 130. After receiving the notification, computer system 130 may perform a remedial action, such as: presenting the notification to a network operator or administrator (e.g., on a display, via an alert or a message, etc.); isolating an effected electronic device(s) (such as disconnecting or disabling communication links with the effected electronic device(s), etc.); reverting to a previous state or configuration (such as by providing instructions to the effected electronic device(s); restoring a previous version of software or an operating system; and/or another type of remedial action. Moreover, computer system 130 may aggregated and store the information, data and/or notifications received from the agents for additional analysis and/or record keeping.

While the preceding discussion illustrated the security techniques with analysis performed by the given agent, in other embodiments at least a portion of the analysis may be performed by computer system 130. Thus, information or data collected by the given agent may be assessed and/or analyzed to determine additional information, and this assessment and/or analysis may, at least in part, be performed locally (e.g., by the given agent), remotely (e.g., by computer system 130), or jointly by the given agent on electronic device 110-1 and/or computer system 130. For example, after receiving the information specifying the collected data or information, computer system 130 may perform at least a portion of the assessment and/or analysis prior to performing any associated remedial action. Note that the communication among electronic devices 110 and/or computer system 130 may be secure (e.eg., encrypted and/or via a tunnel).

In some embodiments, the assessment and/or analysis of the information or the data may be performed using an analysis model that is pretrained or predetermined using a machine-learning technique (such as a supervised learning technique, an unsupervised learning technique, e.g., a clustering technique, and/or a neural network) and a training dataset. For example, the analysis model may include a classifier or a regression model that was trained using: a support vector machine technique, a classification and regression tree technique, logistic regression, LASSO, linear regression, a neural network technique (such as a convolutional neural network technique, an autoencoder neural network or another type of neural network technique) and/or another linear or nonlinear supervised-learning technique. The analysis model may use information or data as inputs, and may output one or more detected changes, one or more first-detection events and/or one or more notifications. Note that computer system 130 may dynamically retrain a given analysis model based at least in part on updates to the training dataset (such as using aggregated or collected information or data, notifications, etc.), and then may optionally provide an updated analysis model to electronic devices 110.

Moreover, in some embodiments, a given electronic device (such as electronic device 110-1) may receive, from computer system 130, a pretrained predictive model based at least in part on user-information provided by electronic device 110-1. For example, electronic device 110-1 may report login information to computer system 130, and in response may receive a pretrained predictive model associated with a user (such as a pretrained predictive model that is trained based at least in part on historical behavior of the user, e.g., different types of activities or personas of the user when using one or more electronic devices, which may include electronic device 110-1). Furthermore, electronic device 110-1 may monitor activity (such as hardware activity and/or software activity) associated with an event (such as intrusion and/or malicious activity) while the user uses electronic device 110-1. Using the pretrained predictive model, electronic device 110-1 may analyze the activity to identify the event, and may provide, to computer system 130, event information specifying a process, which is associated with the event. In response, computer system 130 may provide severity information to electronic device 110-1 that indicates a security risk associated with the event (e.g., based at least in part on the event, computer system 130 may look-up the severity information in a look-up table, may determine the severity information, such as by using a second pretrained predictive model, and/or may receive real-time severity information from a network operator or administrator). Based at least in part on the severity information, electronic device 110-1 may selectively perform the remedial action (such as discontinuing the process and/or changing an alert level for the user, where the alert level corresponds to a deviation from expected behavior of the user, and the changed alert level may lower a threshold value for identification of a subsequent event).

Note that electronic device 110-1 and/or computer system 130 may update the pretrained predictive model and/or the second pretrained predictive model dynamically, periodically and/or as needed. For example, when the severity information indicates that the remedial action is not needed or that retraining is needed, electronic device 110-1 may update the pretrained predictive model based at least in part on the event and the severity information. Alternatively or additionally, electronic device 110-1 may provide, to computer system 130, feedback information (such as the event information and the severity information), and computer system 130 may update the pretrained predictive model based at least in part on the event and the severity information.

In these ways, the security techniques may facilitate improved real-world monitoring and detection of changes and/or first-detection events in a scalable manner and with reduced or eliminated false-positive detections. These capabilities may facilitate accurate and timely remedial action. Consequently, the security techniques may improve security and user satisfaction, and may enhance business activity and trust.

While the preceding discussion illustrated the security techniques with real-time monitoring or detection and selective remedial actions, in other embodiments computer system 130 may perform a retrospective assessment and/or analysis of stored data and information.

We now describe embodiments of the method. FIG. 2 presents a flow diagram illustrating an example of a method 200 for selectively performing a remedial action, which may be performed by an electronic device (such as electronic device 110-1 in FIG. 1), such as agent executing on or in an environment of the electronic device. During operation, the electronic device may receive user information (operation 210) associated with a user of the electronic device. For example, the user information may include login information, such as a username, a password and/or an identifier of or associated with the user. Then, the electronic device may provide, addressed to a computer system, the user information (operation 212).

Moreover, the electronic device may receive, associated with the computer system, a pretrained predictive model (operation 214) associated with the user. For example, the pretrained predictive model may include a neural network. The pretrained predictive model may be associated with multiple electronic devices previously used by the user. In some embodiments, the multiple electronic devices may include the electronic device. Note that the pretrained predictive model may be associated with different types of activities or personas of the user. The pretrained predictive model may be based at least in part on historical behavior of the user.

Furthermore, the electronic device may monitor activity (operation 216) associated with an event while the user uses the electronic device, where the activity includes a hardware activity and/or a software activity. For example, the activity may be associated with or may include: a hardware change, a software change, a memory operation, a type of file accessed, a location of the file, a failed login attempt, user-interface activity, an executed application, and/or communication with another electronic device.

Next, the electronic device may analyze the activity (operation 218) using the pretrained predictive model to identify the event, and may provide, addressed to the computer system, event information (operation 220) specifying a process, which is associated with the event. Note that the event may not have been previously identified by the pretrained predictive model for the user. Additionally, the electronic device may receive, associated with the computer system, severity information (operation 222) that indicates a security risk associated with the event.

Based at least in part on the severity information, the electronic device may selectively perform the remedial action (operation 224). For example, the remedial action may include discontinuing the process associated with the event. Alternatively or additionally, the remedial action may include changing an alert level for the user, where the alert level corresponds to a deviation from expected behavior of the user.

In some embodiments, the monitoring, the analysis, the providing of the event information, the receiving of the severity information, and the selective performing of the remedial action may occur in real-time as the electronic device performs the process associated with the event.

In some embodiments, the electronic device may perform one or more additional operations (operation 226). For example, when the severity information indicates that the remedial action is not needed or that retraining is needed, the electronic device may update the pretrained predictive model based at least in part on the event and the severity information.

Moreover, when the severity information indicates that the remedial action is not needed, the electronic device may provide, addressed to the computer system, feedback information for use in updating the pretrained predictive model, where the feedback information includes the event information and the severity information. Thus, the updating of the pretrained predictive model may, at least in part, be performed by the computer system. In some embodiments, the feedback information may be provided after a current session of the user on the electronic device ends.

In some embodiments of method 200, there may be additional or fewer operations. Furthermore, the order of the operations may be changed, and/or two or more operations may be combined into a single operation.

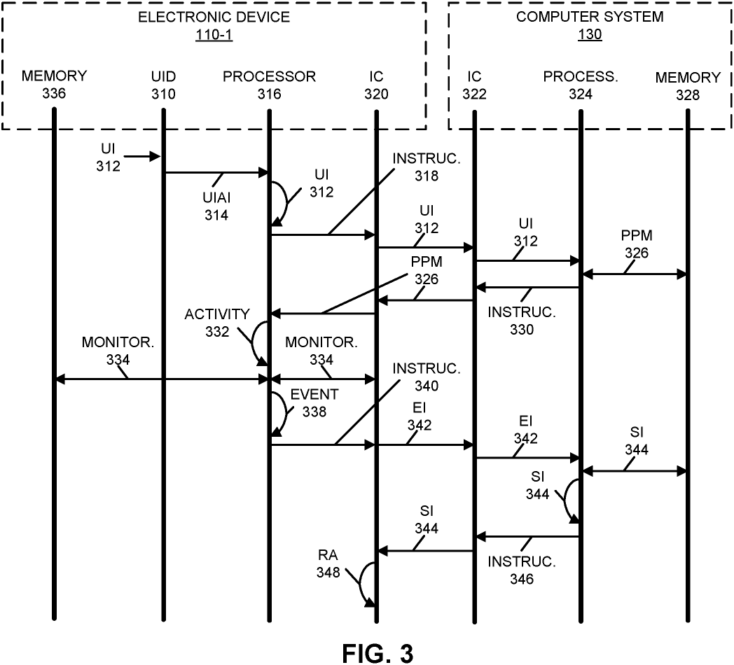

Embodiments of the security techniques are further illustrated in FIG. 3, which presents a drawing illustrating an example of communication among components in electronic device 110-1 and computer system 130. In FIG. 3, a user-interface device (UID) 310 in electronic device 110-1 may receive user information (UI) 312 from a user. In response, user-interface device 310 may provide user-interface activity information (UIAI) 314 to processor 316 in electronic device 110-1, which may extract or convert user-interface activity information 314 into user information 312. Then, processor 316 may instruct 318 interface circuit 320 in electronic device 110-1 to provide user information 312 to computer system 130.

After receiving user information 312, an interface circuit 322 in computer system 130 may provide user information 312 to processor 324 in computer system 130. Then, processor 324 may access a pretrained predictive model (PPM) 326 in memory 328 in computer system 130, and may instruct 330 interface circuit 322 to provide pretrained predictive model 326 to electronic device 110-1. Moreover, after receiving pretrained predictive model 326, interface circuit 320 may provide pretrained predictive model 326 to processor 316.

Furthermore, processor 316 may monitor activity 332 of electronic device 110-1 associated with an event 338. For example, processor 316 may execute an agent in an environment of operating system in electronic device 110-1 to monitor 334 ports in or associated with interface circuit 320 and/or software stored in memory 336 in electronic device 110-1. Additionally, processor 316 may analyze activity 332 using pretrained predictive model 326 to identify event 338, and may provide instruct 340 interface circuit 320 to provide event information (EI) 342 specifying a process, which is associated with event 338.

After receiving event information 342, interface circuit 322 may provide event information 342 to processor 324. In response, processor 324 may access severity information (SI) 344 that indicates a security risk associated with the event in memory 328 or may determine severity information 344 using a second pretrained predictive model. Then, processor 324 may instruct 346 interface circuit 322 to provide severity information 344 to electronic device 110-1.

Moreover, after receiving severity information 344, interface circuit 320 may provide severity information 344 to processor 316. Based at least in part on the severity information 344, processor 316 may selectively perform a remedial action (RA) 348 (such as discontinuing the process associated with event 338).

While FIG. 3 illustrates communication between components using unidirectional or bidirectional communication with lines having single arrows or double arrows, in general the communication in a given operation in this figure may involve unidirectional or bidirectional communication.

We now further describe the security techniques. Agents may work in real-time to dynamically perform on-the-spot or real-time analysis of activity and collect data (either centrally and/or in a distributed manner) from layers of hardware, software, user activity, and/or network connections, including the internal and external subnets of an organization (such as multi DMZ or multi-demilitarized zones) and may establish the severity level of any particular event. (Note that a DMZ may be or may include a perimeter network that protects an internal local-area network or LAN of an organization from untrusted traffic.) Then, information may be fed to a dashboard in real-time, so that network and systems security team members can identify and resolve issues as they happen, while analysis of the endpoints leads to accurate issue identification.

A given agent may provide so-called ‘first detection’ (FD) of a potential anomaly in an electronic device or computer system the first time a change is detected or noticed (which, in the present disclosure, is referred to as a ‘potential anomaly’ or a ‘potential behavioral anomaly’). Thus, the given agent may provide a first detection alert of multiple subjects/processes found in the organization, thereby enabling the users to quickly analyze and act on (or perform a remedial action in response to) new threats or issues in the most effective way.

For example, the security techniques may provide first detection of USB, such as a USB device or a USB interface connection (and, more generally, a connection via an arbitrary type of interface). USB hardware properties (such as a media access control or MAC address) provide a soft unique identifier (UID). An electronic device or a computer system may handle file transition back and forth with this USB and/or may process USB communications. Properties of or associated with USB may include: a USB computer; USB dynamic change of internal file system; and/or Linux live (from Microsoft, Corp. of Redmond, Washington). Note that Linux live includes the use of a USB device or USB drive as a runtime operating-system drive. Thus, a user can boot a computer system from the USB device or the USB drive and other drives may be data drives only. Moreover, the user can boot from the USB device or USB drive and then may mount the other drives and modify them without anyone knowing.

Furthermore, the security techniques may provide first detection (e.g., by an agent) of a new sharing session. Notably, the agent may detect a first file accessed by a user of the current machine (usually a file server) from a remote machine. In some embodiments, this capability may not require that the agent reside on or execute on the remote machine.

Additionally, the security techniques may provide first detection of a remote Internet Protocol (IP) address. Notably, the detection may occur after (or when) a first agent has marked an IP address as new for a specific or particular application. Note that the first agent may not the IP addresses of a Web browser. Instead, the first agent may focus on applications. This may allow the first agent to perform first detection of a web page, a website or a domain.

In some embodiments, the security techniques may provide first detection of a TCP listener port. This first detection may occur after (or when) a first agent has marked an opened listener port as new for a specific application.

Moreover, the security techniques may provide first detection of a process. This first detection may occur after (or when) a first agent has marked a process (e.g., by a checksum) as new on a machine. Note that a ‘new’ process may be identified as occurring for the first time because it did not previously have a checksum.

Furthermore, the security techniques may provide first detection of a change to a process version. This first detection may occur after (or when) a first agent has marked a new version change associated with a process in a machine. Note that this change may include a ‘good’ or normal change.

Additionally, the security techniques may provide first detection of process property anomalies. This first detection may occur after (or when) a first agent has marked a new abnormal change associated with a process in a machine. While the process may appear to be the same, it may not be the same as a normal version upgrade. For example, the checksum may be changed, but the file may be digitally unsigned (while a previous version of the file may have been digitally signed). Alternatively, the file name may be changed, etc. There may also have been a first detection using Yet Another Recursive/Ridiculous Acronym (YARA), which may perform malware detection using a signature.

In some embodiments, the security techniques may provide first detection of a driver. This first detection may occur after (or when) a first agent has identified or recalled a new driver installed on a machine or when there is a significant change.

Moreover, the security techniques may provide first detection of a service. This first detection may occur after (or when) a first agent has identified or recalled a new service was installed on a machine or when there is a significant change.

Furthermore, the security techniques may provide first detection of a service dynamic link library (DLL). This first detection may occur after (or when) a first agent has identified or recalled a new DLL that is assigned to or associated with a current service.

Additionally, the security techniques may provide first detection of software. This first detection may occur after (or when) a first agent has marked an installed software entry as new.

In some embodiments, the security techniques may provide first detection of a registry autorun. This first detection may occur after (or when) a first agent has identified additions or changes to autorun.

Moreover, the security techniques may provide first detection of a scheduler task. This first detection may occur after (or when) a first agent has identified a change to a scheduler task.

Furthermore, the security techniques may provide first detection of a hardware. This first detection may occur after (or when) a first agent has identified new or changed hardware.

Note that, in general, the first agent may detect or identify any new electronic device or change (e.g., hardware and/or software) in an electronic device.

Agents may work in real-time to dynamically perform on-the-spot analysis of activity and collect data from layers of hardware, software, user activity, and/or network connections, including the internal and external subnets of an organization (such as a multi DMZ) and may establish the severity level of any particular event. The collected information may then be fed to a dashboard in real-time, so that network and systems security team members can identify and resolve issues as they happen. Moreover, instant analysis of some or all endpoints may result in accurate issue identification and/or corrective or remedial action (such as providing an alert or notification, isolating a threat, disconnecting one or more affected electronic devices(s), etc.).

In some embodiments, there may be several computers (such as electronic devices 110) in a network. Each computer may include a preinstalled agent. This agent may see or detect anything and everything that occurs (in hardware and/or software) on the computer it is monitoring. The agent may provide the monitored information to a cloud-based computer system (such as computer system 130). However, in other embodiments, the server may be local instead of remote from the computer or servers. In the discussion that follows, a cloud-based computer system is used as an illustration.

The computers (C₁, Cₙ) may be any type of electronic device (e.g., a laptop, a desktop, a server, a handheld electronic device, a portable electronic device, a wearable electronic device, etc.). The cloud-based computer system may have two interfaces: one may be external, and one may be local. The agent may communicate with the cloud-based computer system through either local and/or external connection(s) if the client allows this behavior. As noted previously, each of the computers may have an agent installed and executing on it (such as agents a₁, aₙ) with a unique identifier. The agents may monitor multiple activities (F₁-Fₙ), such as first detection of: USB, remote IP, TCP listener port, a process, a process version change, process property anomalies, driver(s), service(s), service DLL, software, registry autorun, a scheduler task, hardware, new sharing sessions, and/or a new BIOS version detection. These activities are described further below.

In general, a given agent may perform active monitoring. Thus, a given agent may be constantly operating and looking for changes, processes, and/or activities in a given computer. This agent may monitor processes, e.g., two times/second. Every process may be registered in internal memory and a stack may be created to identify which processes are from which location. Every new process that comes onto the computer may being checked to determine whether it is known or new. If one of these processes has never been run on the computer before, it may be categorized as new. This information may be sent to the cloud-based computer system (along with a hash, properties, the identifier of the agent and/or behavioral information). The cloud-based computer system may do the same. Notably, the cloud-based computer system may look at the list of processes to see if a given process is new to the organization. Once it is determined that the process is new, or is not part of the system list, it may be categorized it as a first detection: it is a new process and a first detection.

Once there is a first detection of a process, this process status can be monitored online in real-time (e.g., via the cloud-based computer system). By taking this approach, the system may be extremely effective and may be able to create corresponding information. Notably, each process identifier may be specific to a particular process and this process identifier may be created during the first detection of the new process. By having the agents to getting first-detection information from, e.g., the Internet, this information may only need to be received a few times. Consequently, there may not be a need to perform the detection on each of the computers. Instead, the detection may occur once in the cloud-based computer system, thereby saving time and money. This capability may allow the user, analyst or security manager to only look at or review first detections (which are sometimes referred to as ‘first-detection events’).

Every agent may be responsible for first detection within its own domain (e.g., it’s computer or electronic device). A cloud-based computer system may run across and/or control the agents to ensure a given process is categorized appropriately/correctly.

Note that generating a unique identifier using a message-digest technique or MD5 (and, more generally, a cryptographic hash function) and/or a secure hash technique or SHA-1 is discussed further below.

In some embodiments, the security techniques (e.g., a given agent and/or the cloud-based computer system) may perform first detection of USB (or a connection via an interface or a port). Notably, an electronic device may be connected to a given computer using USB. In some embodiments, the electronic device may be a USB drive or a hard-disk drive (which, in general, are sometimes referred to as a ‘USB device’). In the registry, there may be information about, e.g., the USB drive or a hard-disk drive. Note that this information may be stored in several locations in the registry (e.g., in a distributed manner) based at least in part on a MAC address of the USB drive or the hard-disk drive.

In the case where a machine is being booted by a USB drive or a hard-disk drive having a different operating system, or when a USB drive or a hard-disk drive is taken out of the computer and being used on an external machine, the agent(s) may detect these two types of activities by monitoring the usage time of the hard-disk drives in the system. Note that a trusted platform module (TPM) can be worked around in hardware and, although this is often used to solve external boot issues, the disclosed security techniques offer another detection approach.

Moreover, the security techniques (e.g., a given agent and/or the cloud-based computer system) may perform first detection of a given driver using a randomized content signature. Notably, the location may be randomized and decided on the fly or dynamically by the agent within the drive (such as a USB drive or a hard-disk drive). The process may be as follows. A drive with external memory connected to a computer may have a hardware signature associated with metadata. When the hardware signature changes, the agent may know the drive has changed. However, the agent may not know what has changed. Therefore, when the drive is plugged in to the computer, its signature may be identified. Then, a randomized list of addresses (e.g., 32-bit addresses) may be collected or gathered. Furthermore, when the drive is plugged in, the agent may read what is at a given address. Next, the agent may create a signature (e.g., using SHA-1) of this information to create a unique signature. The agent may compare this signature to the signature gathered during a previous instance when the drive was plugged in. Additionally, the agent may gather or collect a final signature every time the drive is disconnected from the computer. When a device is improperly disconnected, a signature may be generated that creates what is identified as a ‘bad signature.’ Note that the signatures may be managed internally by the agent and/or by the cloud-based computer system.

During first detection of a USB device or drive, an agent may not only scans for a new USB device or drive, but it may also gather or collect a random selection of the hard-disk drive to confirm there are no changes to internal content. When the content is modified (e.g., contents are written to the disk, such as malware), the agent may take a new signature of this USB and its content. This may allow the agent to track changes on the USB device or drive, and each time a change is noted a new signature may be created. The alerts or notifications created in this way may signal that one or more changes have been made to a USB device or drive outside of a known state or configuration in the system.

For example, a USB device or drive may be connected to a computer. Moreover, content may be added/changed internal to the computer. Then, a signature may be created. When this USB device or drive is reconnected to this computer, no alert or notification may be given. However, when the content is altered on the USB device on a different second computer (which may be detected by another instance of the agent executing in an environment on the second computer), there may be an alert or a notification (and this alert or notification may lead to a remedial action). Note that this approach may uses super input/output (I/O) monitoring.

Another approach for a USB device may include storing and using the time of monitoring. For example, the agent and/or the cloud-based computer system may know the last time this USB hardware was monitored by the agent and/or the cloud-based computer system. In some embodiments, a normal versus an encrypted USB device may be used. Thus, if the USB device is not an encrypted USB device, it may trigger an alert or a notification with high importance or priority. Alternatively, if the USB device is encrypted, it may be considered legitimate (and, thus, may not trigger an alert or a notification, or may trigger an alert or a notification with lower or reduced importance or priority).

In some embodiments, the security techniques may use MD5 to generate a given identifier. In general, MD5 by itself may not be unique, given that it is possible to create two files with the same MD5. In order to create a more unique identity for each process, the agent and/or the cloud-based computer system may have multiple identities that are combined to create a completely unique, unrepeatable identity.

Moreover, in order to make the given identifier more unique, the agent and/or the cloud-based computer system may combine MD5 and SHA-1 (or another cryptographic hash or function). The probability of two separate files containing the same MD5 and SHA-1 value may be effectively zero. Note that the given identity may include: an MD5 value, an internal identifier, and/or a SHA-1 value. In general, there may be at least two identities for each track item, if not three or more.

In a new sharing session performed by an agent, the agent may internally monitor the activity and the sharing performed by, e.g., a Windows (from Microsoft Corp. of Redmond, Washington) application programming interface (API). Depending on the processor threshold, the agent may determine how much of the processor cycles or capacity a given session consumes.

Note that, in the present disclosure, sharing may include Windows sharing (via a server message block or SMB). When a user requests access to a computer, the agent and/or the cloud-based computer system may look for situations where the computer is asking for permission to read or delete files on the computer or another computer.

As an example of a session, when the agent and/or the cloud-based computer system interacts with a file in any way, it can find out information about or associated with: a particular user, share requests, files being accessed, if the user is asking for an access or a delete (this may occur with or without the disclosed agent), etc. Moreover, the computer may have a predefined list of users within an organization. When this is the first time a user requests access to a computer, there may be an alert. Moreover, there may be a learning period (having a defined time period). For example, users that come in the next seven days may not initiate or trigger an alert or a notification. However, after seven days, there may be an alert for every new user/electronic device that is connecting to the computer. In general, first detection may occur per user on a given computer.

Note that some embodiments may include any kind of shared service (sharing of Windows, SMB, Windows sharing between computers, etc.). For example, one computer may access another computer, or a machine may access a computer, or vice versa.

Furthermore, the security techniques (e.g., a given agent and/or the cloud-based computer system) may perform first detection of a remote IP address. In general, any change in an IP address or string may be notified as a first detection, and first detection of an IP address may be per application. For companies or organizations that are completely disconnected from a network (such as the Internet), when someone tries to bypass this protection by connecting a mobile phone and creating a bridge to the Internet, the agent and/or the cloud-based computer system may identify the security risk. Consequently, the agent and/or the cloud-based computer system may perform a remedial action, such as disconnecting the network connection. Additionally, when there is an additional IP address added, the agent may send a notification to the cloud-based computer system. In some embodiments, a switch between an internal and an external network or location may signal or trigger an alert or a notification. For example, when a user takes their laptop or electronic device to a new location, an alert or a notification may be triggered. Note that for virtual private networks (VPNs) and/or proxies, the agent and/or the cloud-based computer system may monitor or see what the user is doing, as opposed to monitoring what the router is seeing.

Additionally, the security techniques (e.g., a given agent and/or the cloud-based computer system) may perform first detection of a TCP listener port. Notably, the agent may be able to see the communication direction the user went through and may have the ability to show a new TCP port is being opened (e.g., 8004). When another port opens, there may be an alert or a notification. For a first detection TCP listen port, there may be at least two types of alerts or notifications: a new alert; or a first detection alert.

In any organization (such as a large one), it may be ideal to know which application is open and on which port. For example, a network operator or administrator may see that application X is open and is supposed to be opened on port 8004. Moreover, the network operator or administrator can see it is open on a different port on different machines (e.g., port 8006 instead of port 8004). In this way, the agent and/or the cloud-based computer system may shed light on which ports are open for a given application (e.g., 99% of machines have application X open on port 8004 and 1% have it open on port 8006). By tracking this information, the agent and/or the cloud-based computer system can detect suspicious traffic. Notably, the agent and/or the cloud-based computer system may detect suspicious traffic by analyzing the last connections to see how many ports a user has on an IP address. This may allow IP address scanner detection to be detected (e.g., when users are being accessed from several ports, it may indicate an IP address scanner).

For example, the agent and/or the cloud-based computer system may have an IP address scanner that monitors a new port coming from a machine on a per-application basis. Alternatively or additionally, the IP address scanner may monitor a listener port (where someone from outside an organization can connect). When ports are opened within an organization, there is little concern. The IP address scanner may scan ports on the local network to identify different ports to go to and may scans IP addresses outside of a user’s machine. Moreover, the IP address scanner may have a learning period, so that normal ports can be identified and recorded. This may allow or enable detection and alerting a network operator or administrator of newly opened ports. In some embodiments, the IP address scanner may detect suspicious traffic when there are more than 20 new IP connections/minute (which may be a first-detection event).

In some embodiments, the security techniques (e.g., a given agent and/or the cloud-based computer system) may perform first detection of a process. Notably, the first detection of the process may be associated with memory or virtual memory. For example, the first detection of the process may occur as follows. The agent may monitor running or executing processes in a machine (e.g., 2x/second). Then, the agent may analyze a process to see where it is running and other properties (e.g., what is stored at a location on a hard-disk drive), such as based at least in part on an identifier of the process (which may, at least in part, be determined using a cryptographic hash, such as MD5). Note that, in contrast with existing approaches, the security techniques may perform a comparison of what is on a hard-disk drive and what is in/on memory. Notably, the agent may access the hard-disk drive once and may see what is in memory. When the agent and/or the computer system sees something new to the memory, the agent and/or the computer system may check to see if it is in the same location and if it has the same name. Moreover, when there is a second application or program that it is not running, the agent and/or the computer system may go back again to perform a checksum (or another metric corresponding to the process) to see if the application was replaced. Furthermore, when the application stays in the memory, it may be unlikely that the application can be replaced because it is still running. This approach may reduce the need for comparisons and thus may improve the system performance.

The first detection of the process may differentiate between a user and a superuser (or a user with access privileges that are not limited or restricted). Moreover, the agent and/or the computer system may check (again) every property that is changed and may create a process identifier. The process, therefore, may be uniquely identified based at least in part on multiple properties.

Moreover, when a new process running on a computer is discovered, the agent may send an alert or a notification with an identifier of the process to the cloud-based computer system. The cloud-based computer system may search for this identifier in a look-up table (or data structure) to see if it is running on the computer. When a user in the organization has the exact same process identifier (in general, the same process may have the same MD5, but will have different properties), an alert or a notification may occur in the cloud-based computer system that indicates that this is ‘not a new first detection of this process, but it is a new first detection of an anomaly.’

In the same computer but for process with the same name and different MD5 value, and which is not a new version, another type of alert or notification may occur. For example, the alert or the notification may include an information alert with a new version (e.g., a change of the original name to the name when the process was compiled).

In general, first detection may be related to these and other types of alerts (e.g., anomaly, new version, etc.). When the detection is performed by a new agent or new cloud-based computer system, these events may be instances of first detection.

Moreover, the security techniques (e.g., a given agent and/or the cloud-based computer system) may perform first detection of a changed process version. Notably, a new process or first detection of a process may indicate that there is a new potential process coming. The new process may be associated with three types of new processes: a brand new process; a new version of a process (e.g., the agent and/or the cloud-based computer system may see the same properties of the file, such as a name, a vendor, etc., but it may appear to be a new version and the MD5 value or identifier and the version may change); and a new process property anomaly (e.g., the version may be the same, but the MD5 value or identifier may have changed, which indicates that something has changed within the file). The agent and/or the cloud-based computer system may have the ability to look at the different types of new processes together. Alternatively, the agent and/or the cloud-based computer system may review each type of new process event individually. Note that while these three types of new process events may be tracked by the agent and/or the cloud-based computer system they may categorized separate types of first-detection events.

Furthermore, the security techniques (e.g., a given agent and/or the cloud-based computer system) may perform first detection of process property anomalies. Notably, first detection of a process property anomaly may occur as follows. The agent may read the header and the MD5 value, and may check the properties (such as the properties that can be gathered from the operating system, such as Windows). The agent and/or the cloud-based computer system may not have a version update. Instead, other properties may have changed (e.g., a name change). This may result in a property anomaly. Note that a name change may indicate the same process. Thus, this is not a first detection, but is a changed name of the process. When the same process is changed from a signed to an unsigned version, the agent and/or the cloud-based computer system may report a more-interesting anomaly that is classified as having a higher risk level or priority.

Note that name change may include a change to metadata properties in the header. Notably, the header structure of a process may have many properties that can be checked. While only some of these properties may be monitored by the operating system, the agent may use them as part of the process identity signature.

Additionally, the security techniques (e.g., a given agent and/or the cloud-based computer system) may perform first detection of a driver. The first detection of a driver may be based at least in part on memory and an environment of the operating system. For example, the first detection of a driver may be based at least in part on a file or a group of files. A change in a process (such as a name, an MD5 value, a version or other changes in the driver) may be detected. Notably, the agent and/or the cloud-based computer system may show or present the unit name, the system name, a file path, a product name, a reason (e.g., a first detection of a new driver, a driver checksum, a property change), etc.

In some embodiments, the security techniques (e.g., a given agent and/or the cloud-based computer system) may perform first detection of a service. Note that a service may include the operating system (such as Windows) and may have a vector or an automatic link to: a process, a special process for running applications or automatic applications, and/or background processes. However, these may not be user processes. Instead, they may be mostly automatic processes under Windows control. For example, a GPU may have a service process on Windows that is responsible for keeping it alive or active at all times. A checksum may be run by the agent and/or the computer system to detect changes to the service. Therefore, first detection of a process may identify a change of a service. Note that a service may be similar to a driver, which is run by the operating system. Alternatively or additionally, a service may include a process. For example, a service may be a vector or a process, but it may be run as a service under Windows (e.g., an automatic process).

Moreover, the security techniques (e.g., a given agent and/or the cloud-based computer system) may perform first detection of a DLL. Notably, DLLs may run inside a process and may be dynamically accessed by the process. Content of a DLL file may be changed and may cause the running process to do things it should not. The existing approach for addressing this is to provide a DLL signature and to check it. However, in the disclosed security techniques, the agent and/or the cloud-based computer system may need to have a per-module or per-DLL signature, thereby allowing for changes that are legal (if possible) and to be able to catch malicious changes to a DLL on the fly or dynamically.

The DLLs in a computer may be divided into two sets. One set may include service DLLs and the other set may include some or all of the other or the remaining DLLs (which are not service DLLs). The service DLLs may be monitored by the agent via monitoring process announcements, such as which DLL it needs during runtime and via the operating system, while the other DLLs may be monitored on use by a process and once across the computer or a computer system. For example, when two processes are using the same DLL at the same time, the agent and/or the cloud-based computer system may assess the DLL once, instead of twice.

One of the concerns handled in the security techniques is that DLLs can be partially changed, e.g., not the entire file, but a subset of the functionality in the DLL could be changed without impacting the MD5 value of the entire file. As in other embodiments, the disclosed security techniques may use a combination of MD5 and SHA-1 signatures of every part of the DLL that can be downloaded into a process at runtime.

The monitoring of the service DLLs may be performed by connecting a process to the system DLLs and exercising each of them (which may require the agent and/or the cloud-based computer system to download the DLL modules that the process is invoking). When this DLL module is downloaded, the process can get its signature and verify it. This verification cycle may occur, e.g., 100-200 times per second.

Furthermore, the security techniques (e.g., a given agent and/or the cloud-based computer system) may perform first detection of software. For first detection of software, when an application is installed in the operating system (such as Windows), the agent and/or the computer system may gather information from a Windows inventory. When the agent and/or the computer system identifies a new record of installation of a new application with information (e.g., vendor information), the agent and/or the computer system may note that it is a new installation.

Additionally, the security techniques (e.g., a given agent and/or the cloud-based computer system) may perform first detection of registry autorun. Notably, similar to first detection of services, the agent and/or the cloud-based computer system may register autoruns, e.g., every new entry into the autorun queue, may be checked and, when there is a new entry, the agent and/or the cloud-based computer system may flag it.

In some embodiments, the security techniques (e.g., a given agent and/or the cloud-based computer system) may perform first detection of a scheduler task. Notably, the agent and/or the cloud-based computer system may identify a scheduler task from Windows tasks (which is typically in a different location than autoruns). These tasks may include some or all of the tasks for basic Windows components.

Moreover, the security techniques (e.g., a given agent and/or the cloud-based computer system) may perform first detection of hardware. Notably, the agent and/or the cloud-based computer system may detect the introduction of new hardware to the computer (e.g., a hard-disk drive, a keyboard/mouse, motherboards, a processor, a change on motherboard, BIOS changes, etc.). In some embodiments, the runtime of a driver may be monitored to demonstrate the use of the computer while the agent is not present. This may indicate potential illegal use.

Furthermore, the security techniques (e.g., a given agent and/or the cloud-based computer system) may perform first detection of a new BIOS or operating-system version. When first detection of new malicious activity for the BIOS occurs, the agent and/or the cloud-based computer system may classify it as new. For example, in general a new BIOS version may be downloaded on every new machine. Additionally, the agent and/or the cloud-based computer system may be able to detect versions and timestamps to identify cases where the BIOS was modified without a change to the version. In some embodiments, there may not be alerts on changes to the BIOS, only to the name and version of the BIOS (which may be sufficient). For example, source information can be used by the agent and/or the cloud-based computer system, such as tracking of the run hours of a hard-disk drive (such as for X hours the hard-disk drive was running).

We now describe additional embodiments of the security techniques. Notably, security techniques that leverage an intelligent distributed security agent that supports individual behavioral decisions and continuous learning are described. In these security techniques, the distributed agents are counterparts to a central computer system. The agents may be used to perform new detection of raw data and profiles of electronic devices and computers (which are sometimes referred to as ‘machines’). Note that the given agent may have the ability to kill processes, but it will not crash the operating system. Moreover, the given agent may map memory in a machine and may check/confirm whether a change has occurred. The information collected by the given agent may be stored in a local data structure associated with and managed by the given agent and/or may be shared with the central computer system. The central computer system may leverage the raw data and profiles to perform first detection of potential security threats.

For example, the disclosed agent may work in conjunction with a cloud-based computer system (which may include one or more computers) to understand historical events of a user, e.g., has a user ever previously run a particular process. This agent may be a distributed, smart-based agent.

In the disclosed security techniques, the smart agent may perform local assessments and may send needed information to the cloud-based computer system. This agent may be capable of smart decision-making, statistical associations, severity assessment, etc. Using these security techniques, the cloud-based computer system does not need to have a large number of processes running in attempt to determine severity and make correlations between events. Instead, by freeing up the cloud-based computer system, it can now determine statistical associations between historical data and current status and events.

In some embodiments, there may be a smart agent running on each machine. This agent may report on events that are associated with the operating system (e.g., driver activity) and may be independent of the user of the machine. However, the cloud-based computer system may be notified when a new user logs in. In response, the cloud-based computer system may send back machine-learning code or a pretrained predictive model (e.g., an executable) that the agent uses to assess events locally in order to determine a severity that is directly related to and statistically associated with the user. This user-specific severity may be generated by the agent in real-time.

The security techniques may use user behavior and behavior analysis based at least in part on the electronic ‘breadcrumbs’ that the user leaves behind as they operate a machine, which can be learned by the cloud-based computer system. For example, every user action, such a keystroke, a frequency of keystrokes, networks connections, executed application, searches and queries performed, changes to files, which type of files are accessed, the file locations, etc., may be sent to the cloud-based computer system, which trains or retrains predictive models to lean the patterns associated with the user. Although many network security systems collect such data into a centralized data structure so that it can be analyzed in an attempt to determine changes in behavior, because of the volume of data these network security systems receive they are often unable to perform these capabilities in real-time. Instead, most of these network security systems require minutes or hours to perform retrospective analysis.

In order to solve these problems, the disclose security techniques use distributed machine learning and predictive models that are used by a given agent (which is sometimes referred to as a ‘smart agent’).

Moreover, many network security system that use security-based behavior have difficulty in addressing a user who perform multiple different functions or activities. For example, an information-technology person may develop software on one system and may administer a second system. These two activities are very different and often cannot coexist for purposes of security risk analysis. This incompatibility often leads to failures and unnecessary alerts to already over-taxed information-technology personal.

Therefore, there is a need for security techniques that can react and adapt in real-time to an arbitrary change in user behavior and that can handle such events in a distributed manner across multiple machines and user persona for a given machine. Furthermore, these security techniques may be able to learn and dynamically adapt to user behavior changes while reducing or minimizing extensive alerts to the information-technology operators. Additionally, the security techniques may be performed while learning data is collected by the edge machine(s) that are currently in use by one or more users.

The disclosed network security system may include a cloud-based computer system that receives real-time events from distributed agents and that leverages knowledge and processing that is available to or that is performed by the cloud-based computer system. In some embodiments, the amount of data being received and processed may be reduced or minimized relative to existing network security systems. In addition, the number of alarms/alerts that are being monitored by a network operator or administrator of the network security system may be reduced or minimized.

In some embodiments, the disclosed network security system may use an evolutionary neural model. Notably, based at least in part on existing data (e.g., in the cloud-based computer system) the network security system may ‘grow’ and train the neural model. If the data includes or corresponds to multiple instances of monitored hardware, the network security system may train multiple neural models. These neural models may be merged into a single neural model that includes the behavioral characteristics of the combined behaviors. Subsequently, a user may be associated with a single base neural model in the network security system. Moreover, when the user accesses a machine (e.g., by logging into the machine), the base neural model may be downloaded to or accessed by the agent, which then uses this neural model to decide on an alert level and a risk level that is posed to the machine by every operation that the user performs in real-time and to the machine (which is local to the agent). When the user operates outside of normal for a given neural model, the alert level may be higher or may be increased (or a threshold value may be reduced). Furthermore, acknowledgments to the alerts from a network operator or administrator of the network security system may be used to teach the neural model more about this user and to update the neural model via continuous learning. Note that, at the end of the current session, when the user logs out of the machine, the updated neural model may be combined with the previous base neural model to create a new base behavioral neural model for this user. This new base neural model may be loaded into or accessed by the agent on the next machine the user logs into.

In general, the disclosed security techniques may address the problem of having a machine-learning or predictive model or object for each individual/computer/hardware instantiation, e.g., a machine-learning object for every machine a user may access. Notably, while each artificial-intelligence object may learn the unique behavior of the user in the unique environment of the monitored hardware or machine(s), in the disclosed security techniques there may be a single artificial-intelligence object or neural model per individual or user regardless of the number of machines that they access over time.

In some embodiments, the security techniques use NE techniques adopted to these problems. In the discussion that follows, we start with a discussion of some historical background. Then, we add elements in order for the security techniques to solve the specific set of problems discussed previously.

### NE Techniques

In some embodiments, NE, which is the artificial evolution of neural networks using genetic techniques, has shown great promise in complicated reinforcement learning tasks. NE typically searches through a space of behaviors for a neural network that performs well at a given task. This approach to solving complicated control problems represents an alternative to statistical techniques that attempt to estimate the utility of particular actions in particular states of the world. Because NE searches for behavior instead of a value function, it is often effective in problems with continuous and high-dimensional state spaces. In addition, because memory may be represented through recurrent connections in neural networks, NE a usually natural choice for learning non-Markovian tasks and making sense of them, e.g., in security problems.

For all these reasons, NE may be used to represent behavior modeling and monitoring using machine-learning or pretrained predictive models. However, in traditional NE approaches, a topology is often chosen for the evolving neural networks before the experiments or the measurements begin. In the disclosed security techniques, the neural network is evolved to maintain consistency without losing innovation inside the topology. Notably, the neural network may be evolved to capture new individual behaviors based at least in part on how they handle computer-based tasks that are viewed as events (which is described further below).

In order to solve the innovation problem, in the disclosed security techniques we may use NE to evolve both topologies and weights while minimizing the dimensionality of the search space of connection weights.

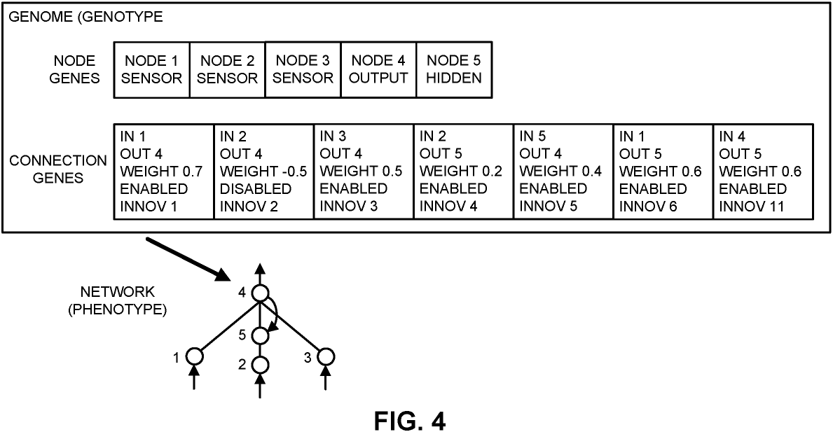

FIG. 4 presents a drawing illustrating an example of genotype-to-phenotype mapping. Notably, a genotype that produces a phenotype is depicted. There are three input nodes, one hidden node, and one output node, and seven connection definitions, one of which is recurrent. Moreover, the second gene is disabled, so the connection that it specifies (between nodes 2 and 4) is not expressed in the phenotype.

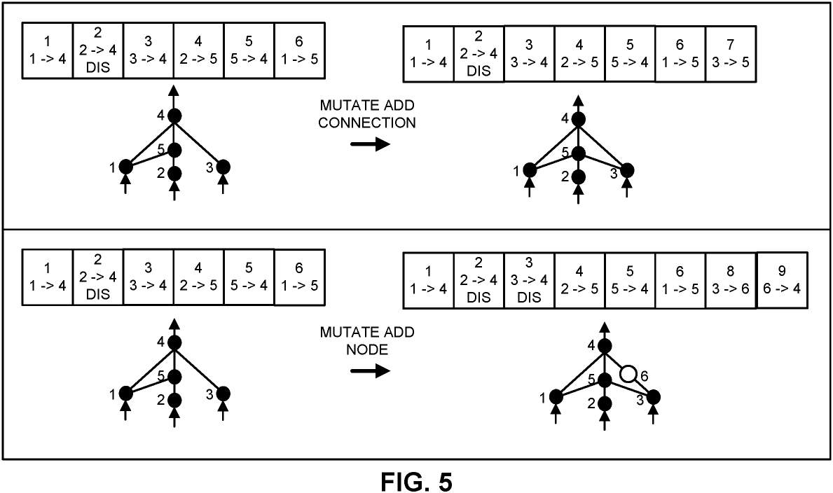

FIG. 5 presents a drawing illustrating an example of two types of structural mutation. Notably, the two types of structural mutation (adding a connection and adding a node) are illustrated with the connection genes of a neural network shown above their phenotypes. The top number in each genome is the innovation number of that gene. The innovation numbers may be historical markers that identify the original historical ancestor of each gene. Moreover, new genes may be assigned new, increasingly larger numbers. When adding a connection, a single new connection gene may be added to the end of the genome and given the next available innovation number. Alternatively, when adding a new node, the connection gene being split may be disabled, and two new connection genes may be added to the end of the genome. The new node may be between the two new connections. A new node gene (not depicted) representing this new node may also added to the genome.

### Genetic Encoding

A genetic encoding technique may be designed to allow corresponding genes to be easily lined up when two genomes cross over during mating. As shown in FIG. 4, genomes may be linear representations of neural-network connectivity. A given genome may include a list of connection genes, which each may refer to two-node genes being connected. Moreover, node genes may provide a list of inputs, hidden nodes, and outputs that can be connected. Each connection gene may specify the in-node, the out-node, the weight of the connection, whether or not the connection gene is expressed (e.g., an enable bit), and an innovation number, which may allow corresponding genes to be identified or determined. Furthermore, mutation may change connection weights and/or neural-network structures.

In the NE techniques, connection weights may mutate, with each connection either perturbed or not at each generation. As shown in FIG. 5, structural mutations may occur in two ways. Each mutation may expand the size of the genome by adding gene(s). In the add connection mutation, a single new connection gene with a random weight may be added connecting two previously unconnected nodes. Alternatively, in the add node mutation, an existing connection may be split and the new node may be placed where the old connection used to be. The old connection may be disabled and two new connections may be added to the genome. The new connection leading into the new node may receive a weight of ‘1,’ and the new connection leading out may receive the same weight as the old connection. This method of adding nodes may be used in order to minimize the initial effect of the mutation. Moreover, while the new nonlinearity in the connection may change the function slightly, the new nodes may be integrated into the neural network, as opposed to adding extraneous structure that would have to be evolved into the neural network subsequently. Note that, because of speciation, the neural network may have time to optimize and make use of its new structure.

Furthermore, by using this structure to represent a topology, information in evolution may indicate which genes match up with which counterpart genes between any individuals in a topologically diverse population. This information may indicate the historical origin of each gene. Note that two genes with the same historical origin may represent the same structure (although possibly with different weights), because they were derived from the same ancestral gene at some point in the past. Thus, in order to know which genes line up with which, a network security system may keep track of the historical origin of every gene. Whenever a new gene appears (e.g., through structural mutation), a global innovation number may be incremented and assigned to that gene. Therefore, the innovation numbers may represent a chronology of the appearance of every gene in the network security system. (Consequently, FIG. 4 includes the innovation (Innov) number.)

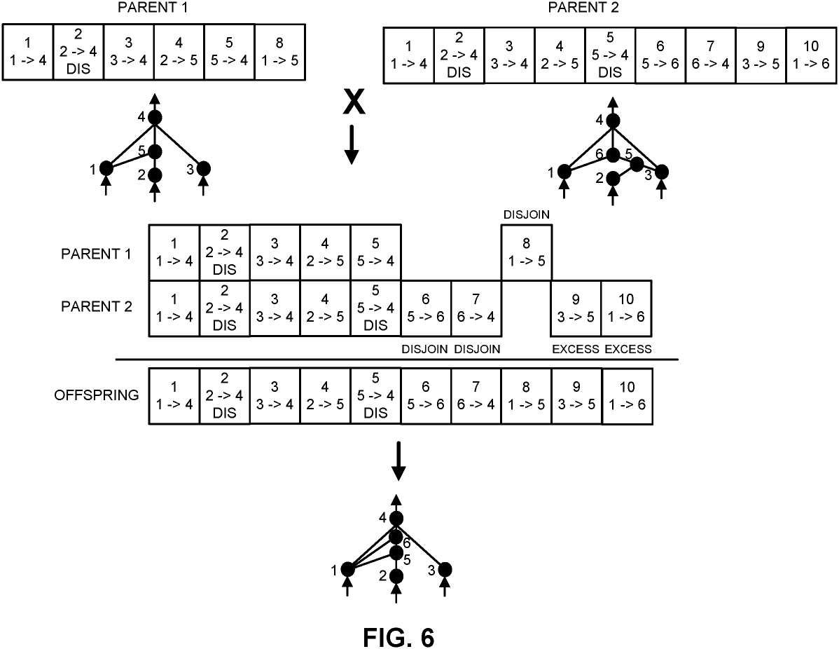

FIG. 6 presents a drawing illustrating an example of matching up genomes for different network topologies using innovation numbers. Although parent 1 and parent 2 appear to be different, their innovation numbers (shown at the top of each gene) indicate which genes match up with which. Even without any topological analysis, a new structure that combines the overlapping parts of the two parents, as well as their different parts, may be created. Moreover, matching genes may be inherited randomly, whereas disjoint genes (e.g., those that do not match in the middle) and excess genes (e.g., those that do not match in the end) may be inherited from the more fit parent. In this case, equal fitness may be assumed, so the disjoint and excess genes may also be inherited randomly. Furthermore, the disabled genes may become enabled again in future generations. Thus, there is a preset chance that an inherited gene may be disabled if it is disabled in either parent. By adding new genes to the population and sensibly mating genomes representing different structures, the network security system may form a population of diverse topologies.

### Developing the Network Security System

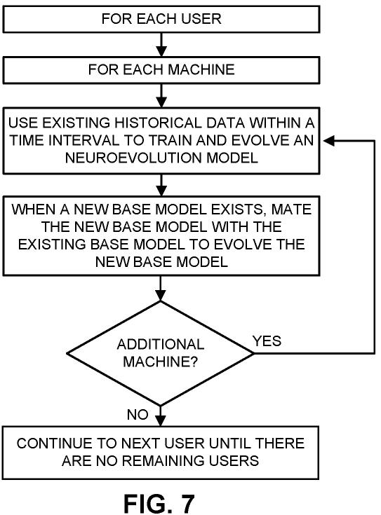

In the disclosed security techniques, individuals or users, who are the actors that operate in a system by doing their normal day-to-day jobs, are considered. Each actor may present a different level of risk to the organization by performing their normal day-to-day activities. These actors have what is called ‘normal’ behavior. Additionally, there may be normal behavior for each organization, which may be expected to vary from one organization to another. This normal behavior may include information about: files accessed, the time of the day, for how long, are these files or operations performed during working hours, was remote access used, login and log out events, what electronic device was accessed, etc. In order to track and assess this data, there may be an artificial-intelligence or machine-learning process, per user/individual. This artificial intelligence may include an NE object that is evolved initially using existing historical information as shown by the pseudocode in Table 1. This process is further illustrated in FIG. 7, which presents a flow diagram illustrating an example of a method for evolving an NE object of a user using an electronic device in FIG. 1.

TABLE 1

```
1. For each user
    2. For each machine
            2.1 Feed existing historical data within a time interval into an NE neural model to train and evolve it.
            2.2 If a base neural model exists, mate the new neural model with the existing base neural model to evolve a new base neural model.
            2.3 GO TO 2.1 until there are no more machines
    3. GO TO 1 until there are no more users
```

After this initial phase, a base NE neural model that represents each individual in the organization may be determined.

Note that speciating the population may allow organisms to compete primarily within their own niches instead of with the population at large. This way, topological innovations may be protected in a new niche where they have time to optimize their structure through competition within the niche. The idea may be to divide the population into species, such that similar topologies are in the same species. This task may involve a topology matching problem. However, once again, historical markings may offer an efficient solution. Notably, the number of excess and disjoint genes between a pair of genomes may be a natural measure of their compatibility distance. The more disjoint two genomes are, the less evolutionary history they share, and thus the less compatible they may be with each other. Therefore, the compatibility distance δ of different structures in the network security system may be determined based at least in part on a linear combination of the number of excess E and disjoint D genes, as well as the average weight differences Cᵢ of matching genes W, including disabled genes: δ = c₁•E/N + c₂•D/N + c₃ •W.

Note that the coefficients c₁, c₂, and c₃ may be used to adjust the relative importance of the three factors. Moreover, the factor N, which is the number of genes in the larger genome, may be used to normalize for genome size (N may be set to ‘1’ if both genomes are small, such as fewer than 20 genes). The compatibility distance or distance measure δ may allow the network security system to speciate using a compatibility threshold δt. Furthermore, an ordered list of species may be maintained. In each generation, genomes may be sequentially placed into species. Each existing species may be represented by a random genome inside the species from the previous generation. Furthermore, a given genome g in the current generation may be placed in the first species in which g is compatible with the representative genome of that species. This way, species may not overlap. If g is not compatible with any existing species, a new species may be created with g as its representative.

### Speciating

In embodiments with a centralized model, the speciating may be performed by the cloud-based computer system. Notably, the neural model may initially be used to evolve an ideal genome that represents an individual operating on a single piece of hardware. Subsequently, assuming the distance between different genomes is not too large, multiple characteristics may be combined as this individual operates on multiple pieces of hardware. In some embodiments, a single individual may have multiple genomes that represent their behaviors within multiple disparate machines or modes of behaviors. Moreover, in some embodiments, these genomes may be combined into a single genome that represents this individual operating on all the combined machines with all the combined behaviors. Note that, in either embodiment, the neural model may be unique to the individual.

In some embodiments, the speciating model may be used in the evolution of a single individual base NE neural model and this base neural model may also be used to generate speciating across an entire organization. When this speciating is employed across the organization, individuals who share behavior may be allowed to be part of a single species. In general, this capability may allow the population to be monitored on a species basis and to look for anomaly behavior based at least in part on species as opposed to an individual. Therefore, this capability may reduce the number of events that the network security system may see and, thus, may allow faster anomaly monitoring in real-time.

In order to support continuous learning on an individual basis in the network security system, every event from the corresponding agent may be processed by the NE neural model in order to determine if a particular event is an anomaly or a risk to the organization. Because the NE neural model may retain historical information in its structure and may represent normal for the individual, the NE neural model may be able to identify a potential issue for a network operator or administrator to check and/or for the cloud-based computer system to automatically evaluate.

In some embodiments, events that have been identified as out of a normal range may be flagged and sent to a user interface. When an event is flagged, a network operator or administrator may be notified to assess the event. The network operator or administrator may decide whether this event is within the normal range or not. When the network operator or administrator decides that an event is within the normal range, this information may feedback to a machine-learning system or module (or a set of program instructions) in the network security system. This may facilitate reinforcement learning and, more specifically, recourse reinforcement learning.

At a high level, there may be a two-stage machine-learning system. In the first stage, the machine-learning system may look at everything that happens and may learn from this information. In the second stage, the machine-learning system may receive or may access real-time events and may choose whether or not to raise the bar or to revise what is considered normal. This bar or threshold may correspond to a probability of an issue occurring with an event (e.g., a higher probability of an issue versus a lower probability of an issue). The probability scale may be an output of the machine-learning system and may have a value between 0 to 10 or, as a percentage, between 0-100%. This output is sometimes referred to as a ‘severity level.’

When the machine-learning system identifies low-probability events, there may not be an alert. Alternatively, when the machine-learning system identifies a high-probability event, the network security system may be provided a ‘red alert.’

Note that the disclosed security techniques may use machine learning (such as a neural network and, more generally, a machine-learning model that is trained using a supervised-learning technique and/or an unsupervised-learning technique) that is a combination of these parameters. Notably, at the input, the machine-learning system may impact the severity level or the situation on some or all of the outputs.

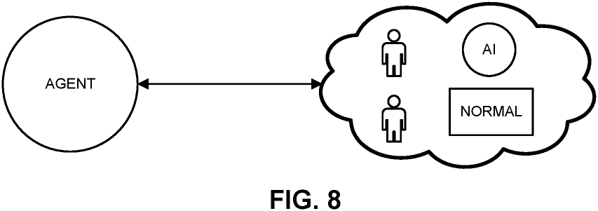

As previously described, there may be normal ranges for individuals and/or organizations. In an organization, there may be different normal ranges across different portions of the organization. This is illustrated in FIG. 8, which presents a drawing illustrating an example of monitoring of normal behavioral ranges of a user using an agent. Through identifying the normal ranges per individual and/or per organization, the network security system may create classes or families of user or organization behavior. This is expected for most organizations and, by creating and comparing different classes or families, the network security system can identify patterns. Alternatively or additionally, in the security techniques, different classes or families may be group (e.g., using a clustering technique) into different species. Table 2 illustrates examples of different alert types and occurrences.

TABLE 2

| Alert Type | Occurrences |
|---|---|
| Login Failure | 1354 |
| Universal Serial Bus (USB) Usage Tracking | 123 |
| Process Property Anomalies | 12 |
| New Process | 846 |
| New Software | 21 |
| New Remote Internet Protocol Address | 456 |
| Process Version Changed | 12 |
| First Detection (FD) Process Version Changed | 45 |
| Suspicious Traffic | 154 |
| FD Remote Internet Protocol Address | 466 |
| Transmission Control Protocol (TCP) Remote Desktop Protocol (RDP) Listeners | 54 |
| Remote Desktop Detected | 50 |

Table 3 provides an example of the information included in a user interface that may be presented to an information-technology professional. This user interface may map the general user behavior to a correlation score, behavioral changes, species type, and/or the organizational species name.

TABLE 3

| | | | | |
|---|---|---|---|---|
| User [Genome Identifier] | Correlation Score | Persona Behavioral Change Relative to Normal | Species Type Relative to Change | Organizational Species Name |
| BIDomain\userA | 1564 | +300% | +220% | Information-Technology Persona |
| BIDomain\userB | 513 | +120% | +10% | Developer Persona |
| DomX\UserJ | 16878 | +50% | -15% | Administrator Persona |
| DomX\UserA | 2043 | +22% | +33% | Human-Resources Persona |
| DomX\UserG | 128 | +90% | -65% | Finance Persona |
| DomX\UserC | 1698 | +280% | +110% | Administrator |
| | | | | Persona |

Table 4 provides an example of base event that may be input to the machine-learning system. Notably, Table 4 illustrates a set of events that are used as inputs into the genome (or pretrained predictive model, such as the NE neural model). In response, the genome may provide a percentage correlation between what is observed to what is considered normal for this persona.

TABLE 4

Account Audit

| Log On - Log Off | Login Failure | Parallel User Login | Unconventional Working Hours | Login Failure By Service |
|---|---|---|---|---|
| File and Media Activity | | | | |
| Removable and Mobile Devices | USB Usage Tracking | USB Files Activity | First Detection of USB | USB Connected |
| Shared Access | Most Active Users | Most Active Machines | Multi Machines User Sharing Activity | New Sharing Session |
| Most User Sharing Files Activity | Sensitive Data Accessed | Sensitive Net Share File Accessed | Sensitive USB File Accessed | Sensitive Local File Accessed |
| Network | | | | |
| Adapter | Adapter Internet Protocol Address Change | Adapter Added | Adapter Removed | Adapter Direction Type Changed |
| Adapter Connection State | Adapter TCP Error | Adapter Domain Name System (DNS) Changed | Connectivity | Cable Unplugged |
| Cable Plugged | Connected Wireless Network | Disconnected Wireless Network | New Remote IP | FD Remote Internet Protocol Address |
| New TCP Listener Port | FD TCP Listener Port | Suspicious Traffic | TCP RDP Listeners | Remote Desktop Detected |
| Software | | | | |
| New Software | New Software or Operating System Updates | Driver | New Driver | Driver Changed |
| Service | New Service | Service Changed | New Service Dynamic Link Library (DLL) | Service DLL Changed |
| Scheduler Task | New Scheduler Task | Scheduler task Changed | Registry Autorun | New Registry Autorun |
| Registry Autorun Changed | | | | |
| Process | | | | |
| Process Property Anomalies | New Process | Process Behavior Anomalies | Process Version Changed | Suspicious Execution |
| Suspicious Command | New Malicious Process | | | |
| First Detection (FD) | | | | |
| First Detection Process | FD Driver | FD Process Property Anomalies | FD Process Version Changed | FD Service |
| FD Software | FD Registry Autorun | FD Service DLL | FD Scheduler Task | |
| Hardware | | | | |
| Hardware Changed/ Removed | New Hardware Detection | FD of Hardware | High CPU | Bios Changed |
| Special Web Activity | | | | |
| Social Networking | Facebook | Twitter | LinkedIn | Google+ |
| Pinterest | YouTube | Instagram | Cloud & P2P Networking | Dropbox |
| Google Drive | Mega.nz | OneDrive | Web Mail | Outlook |
| Gmail | Yahoo | AOL | iCloud Mail | Gmx |
| Google Inbox | Other Web Mails | Suspicious Uniform Resource Locator or Uniform Resource Identifier | | |

Note that the data structure, or a human persona agent portion, may be being trained in the cloud-based computer system based at least in part on historical data. In addition, the pretrained predictive model may be updated or retrained in real-time based at least in part on current events. For example, there may be immediate training, such that if information is sent back (e.g., by the network operator or administrator) with a higher severity, there may be immediate feedback sent to the machine-learning system. This highly distributed learning system may allow the network security system to run part of our network structure in the agent as opposed to just the cloud-based computer system. Consequently, in some embodiments, the security techniques may be implemented in a centralized and/or a distributed manner. Moreover, while the discussion illustrated the computer system in the network security system as being cloud-based, in some embodiments, the computer system may be implemented within an organization, such as inside of the firewall of an organization. Therefore, local and/or remote implementations may be used.

In general, the cloud-based computer system may consider all of the normal events and all historical events/data. For example, if a system is operating differently with a user, and this is not the first time this user has been using the system or when the user is operating during off hours, the cloud-based computer system may look at historical data to confirm whether these events are concerning. Note that in some embodiments, this type of correlation (and, more generally, statistical association) may be performed by the cloud-based computer system, as opposed to be the agent.

Additionally, this implementation may allow for a new type of correlation and may be engaged when there is a triggering severity. When this occurs, the cloud-based computer system may use historical events and data to correlate information and to identify any concerning events. In these ways, the network security system may catch previously unnoticed events that could be deemed malicious or abnormal for a system. This can encourage the information-technology profession (such as the network operator or administrator) to take a deeper look into these abnormalities.

### Users Across Electronic Devices: Combined Neural Networks

Because the security techniques use a distributed agent every time a user connects to or uses a machine, the network security system may learn from this specific machine. However, this learning may not be shared between machines. For example, if one machine is a database and another is a normal or usual machine for web browsing, the user behaviors may be very different. This may pose a problem: how is information distributed from the cloud-based computer system to the agents, or how does a distributed artificial intelligence system share the learning? In order to address this problem, when a user is done working on all machines, the network security system may generate a combined neural network based at least in part on the neural models for all these electronic devices and may create a new neural network that represents this user across all the electronic devices. In the NE neural model, two genomes may be combined into a single genome that supports more capabilities. However, more generally, predictive models for different machines or user behaviors may be combined into a single predictive model (which may or may not include a NE neural model).

When a user is logged into a system, the agent on that system may receive the combined predictive model as opposed to the single electronic-device/machine predictive model. The combined predictive model may enable multiple, unique behaviors that are machine-specific yet can coexist for a specific user. For example, a user may have multiple personas that can be combined into a single predictive model for the user.

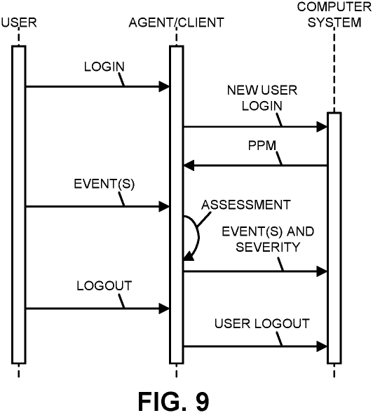

FIG. 9 presents a drawing illustrating an example of communication among an electronic device associated with a user, a client or an agent, and a computer system in FIG. 1. Notably, FIG. 9 illustrates an example of normal operation without the learning process. For example, how an agent receives a neural network or the genome and runs every event through the genome to see correlations or to evaluate normal behavior. As shown previously in Table 3, a user interface with correlation information may be presented to the network operator or administrator in real-time.

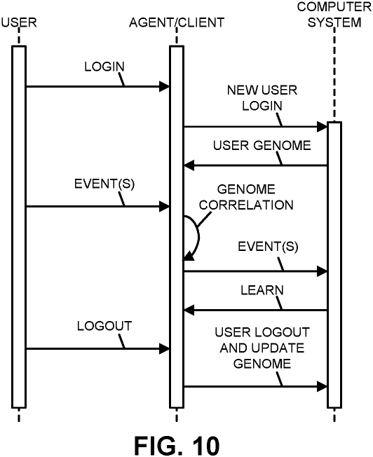

FIG. 10 presents a drawing illustrating an example of communication among an electronic device associated with a user, a client or an agent, and a computer system in FIG. 1. Notably, FIG. 10 illustrates an example of operation with learning. Notably, the cloud-based computer system may notify or ask the agent to learn a new event (as allowed or not allowed by the user) when the events sent to the cloud-based computer system indicate a potential risk or issue. The operations may include: the user logs in to a system; the agent notifies the cloud-based computer system and receives a new genome (or pretrained predictive model) that represents the user persona. Every event generated by user activity may be assessed by the agent using the genome. In addition to the event being sent to the cloud-based computer system, the agent may update information from the genome about the correlation of this event to this user’s normal behavior. The cloud-based computer system may respond with a learn instruction or command that may include positive learning or feedback, e.g., this is an acceptable operation for this user, or a negative learning or feedback, e.g., this operation is illegal for this user. In case of positive feedback, the agent may add this state/event as positive feedback to the continuous learning of the agent. Alternatively, in case of negative feedback, the agent may increase the divergence from normal for this activity and this user.

Note that the learning or revisions to the pretrained predictive model may be sent to the cloud-based computer system when the user exits or, as needed, by the agent or the cloud-based computer system. For example, if the user is logged into multiple systems at once, the cloud-based computer system may integrate the learnings from the agents and may re-send a new or updated genome to the agents. In these embodiments, the learning based at least in part on the data from multiple agents may be performed in concert. In some embodiments, the learning from multiple agents may be performed at the end of a session on each of the agents. Consequently, in these embodiments, the learning may be performed serially, such as based at least in part on the sequence of session termination.

In some embodiments, a checksum of the BIOS may be used by a given agent check for changes. Alternatively or additionally, hardware drivers may be dynamically downloaded to a given electronic device, so that what is going on in the given electronic device can be monitored and/or analyzed. Note that the agent may not determine the severity level. Instead, the agent may receive a severity code that is generated based at least in part on an identifier of an alert. For example, there may be codes for events, which are related to an alert and a specific sub alert. In some embodiments, there may be 8000-12000 codes. This information may be translated by the cloud-based computer system into the corresponding severity. In some embodiments, a correlation widgit may be used. This may indicate a correlation between USB and sensitive USB files.

Note that the agent may categorize an event type and the subcategory to which it belongs. The cloud-based computer system may control how this information is interpreted and how to decide if it is a low, medium or high alert. The cloud-based computer system may ask the agent to block activities (this may be performed automatically).

When the agent sees a process, it may send it to the cloud-based computer system. In response, the cloud-based computer system may identify this process as a FD if it is a FD. If the process is a FD, the cloud-based computer system may request information from a threat exchange server (e.g., in the cloud, and which may or may not be included in the network security system) and may receive information that indicates whether this process is malicious or not. Depending on the severity (e.g., more than 55% of vendors indicating the process is malicious), the cloud-based computer system may automatically initiate an instruction or a command to the agent to suspend the process, shut down machine, terminate process, etc. The action taken may be predefined and based at least in part on a threshold value. This threshold value may determine a mapping to a remedial action.

Thus, agent(s) may send a new process to the cloud-based computer system. For example, every agent may send instances of new processes. The cloud-based computer system may see the first one (FD) or may identify an FD using a hash (which may not include MD5 or a secure hash). The hash may indicate if the process is or is not a new process. If the hash is not in the data structure of known processes, it may be marked as a FD. If the process is a FD, it may be sent to the threat exchange server for analysis. Thus, the security techniques may include per-agent and/or per-FD information about events and/or processes that are sent to the cloud-based computer system and the threat exchange server.

Note that if, for the same machine, the same previously suspended process is running again, the cloud-based computer system may instruct the machine to suspend the process. This may provide more time for detection and killing of processes, and may ensure that it takes longer for a process to occur again.

We now describe embodiments of an electronic device, which may perform at least some of the operations in the security techniques. FIG. 11 presents a block diagram illustrating an example of an electronic device 1100, e.g., one of electronic devices 110, access points 116, radio node 118, switch 128, and/or a computer or server in computer system 130, in accordance with some embodiments. For example, electronic device 1100 may include: processing subsystem 1110, memory subsystem 1112, and networking subsystem 1114. Processing subsystem 1110 includes one or more devices configured to perform computational operations. For example, processing subsystem 1110 can include one or more microprocessors, ASICs, microcontrollers, programmable-logic devices, GPUs and/or one or more DSPs. Note that a given component in processing subsystem 1110 are sometimes referred to as a ‘computation device’.

Memory subsystem 1112 includes one or more devices for storing data and/or instructions for processing subsystem 1110 and networking subsystem 1114. For example, memory subsystem 1112 can include dynamic random access memory (DRAM), static random access memory (SRAM), and/or other types of memory. In some embodiments, instructions for processing subsystem 1110 in memory subsystem 1112 include: program instructions or sets of instructions (such as program instructions 1122 or operating system 1124), which may be executed by processing subsystem 1110. Note that the one or more computer programs or program instructions may constitute a computer-program mechanism. Moreover, instructions in the various program instructions in memory subsystem 1112 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1110.

In addition, memory subsystem 1112 can include mechanisms for controlling access to the memory. In some embodiments, memory subsystem 1112 includes a memory hierarchy that comprises one or more caches coupled to a memory in electronic device 1100. In some of these embodiments, one or more of the caches is located in processing subsystem 1110.

In some embodiments, memory subsystem 1112 is coupled to one or more high-capacity mass-storage devices (not shown). For example, memory subsystem 1112 can be coupled to a magnetic or optical drive, a solid-state drive, or another type of mass-storage device. In these embodiments, memory subsystem 1112 can be used by electronic device 1100 as fast-access storage for often-used data, while the mass-storage device is used to store less frequently used data.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). (While FIG. 11 includes one or more antennas 1120, in some embodiments electronic device 1100 includes one or more nodes, such as antenna nodes 1108, e.g., a metal pad or a connector, which can be coupled to the one or more antennas 1120, or nodes 1106, which can be coupled to a wired or optical connection or link. Thus, electronic device 1100 may or may not include the one or more antennas 1120. Note that the one or more nodes 1106 and/or antenna nodes 1108 may constitute input(s) to and/or output(s) from electronic device 1100.) For example, networking subsystem 1114 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 1100 may use the mechanisms in networking subsystem 1114 for performing simple wireless communication between electronic devices, e.g., transmitting advertising or beacon frames and/or scanning for advertising frames transmitted by other electronic devices.

Within electronic device 1100, processing subsystem 1110, memory subsystem 1112, and networking subsystem 1114 are coupled together using bus 1128. Bus 1128 may include an electrical, optical, and/or electro-optical connection that the subsystems can use to communicate commands and data among one another. Although only one bus 1128 is shown for clarity, different embodiments can include a different number or configuration of electrical, optical, and/or electro-optical connections among the subsystems.

In some embodiments, electronic device 1100 includes a display subsystem 1126 for displaying information on a display, which may include a display driver and the display, such as a liquid-crystal display, a multi-touch touchscreen, etc. Moreover, electronic device 1100 may include a user-interface subsystem 1130, such as: a mouse, a keyboard, a trackpad, a stylus, a voice-recognition interface, and/or another human-machine interface.

Electronic device 1100 can be (or can be included in) any electronic device with at least one network interface. For example, electronic device 1100 can be (or can be included in): a desktop computer, a laptop computer, a subnotebook/netbook, a server, a supercomputer, a tablet computer, a smartphone, a smartwatch, a cellular telephone, a consumer-electronic device, a portable computing device, communication equipment, a monitoring device and/or another electronic device.

Although specific components are used to describe electronic device 1100, in alternative embodiments, different components and/or subsystems may be present in electronic device 1100. For example, electronic device 1100 may include one or more additional processing subsystems, memory subsystems, networking subsystems, and/or display subsystems. Additionally, one or more of the subsystems may not be present in electronic device 1100. Moreover, in some embodiments, electronic device 1100 may include one or more additional subsystems that are not shown in FIG. 11. Also, although separate subsystems are shown in FIG. 11, in some embodiments some or all of a given subsystem or component can be integrated into one or more of the other subsystems or component(s) in electronic device 1100. For example, in some embodiments program instructions 1122 are included in operating system 1124 and/or control logic 1116 is included in interface circuit 1118.

Moreover, the circuits and components in electronic device 1100 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1114 and/or electronic device 1100. The integrated circuit may include hardware and/or software mechanisms that are used for transmitting signals from electronic device 1100 and receiving signals at electronic device 1100 from other electronic devices. Aside from the mechanisms herein described, radios are generally known in the art and hence are not described in detail. In general, networking subsystem 1114 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the security techniques may be implemented using program instructions 1122, operating system 1124 (such as a driver for interface circuit 1118) or in firmware in interface circuit 1118. Thus, the security techniques may be implemented at runtime of program instructions 1122. Alternatively or additionally, at least some of the operations in the security techniques may be implemented in a physical layer, such as hardware in interface circuit 1118.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the security techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a computer system;
a computation device coupled to the interface circuit;
memory, coupled to the processor, configured to store program instructions, wherein, when executed by the computation device, the program instructions cause the electronic device to perform operations comprising:
receiving user information associated with a user of the electronic device;
providing, addressed to the computer system, the user information;
receiving, associated with the computer system, a pretrained predictive model associated with the user;
monitoring activity associated with an event while the user uses the electronic device, wherein the activity comprises a hardware activity, a software activity or both;
analyzing the activity using the pretrained predictive model to identify the event;
providing, addressed to the computer system, event information specifying a process, which is associated with the event;
receiving, associated with the computer system, severity information that indicates a security risk associated with the event; and
selectively performing a remedial action based at least in part on the severity information.

2. The electronic device of claim 1, wherein the user information comprises login information.

3. The electronic device of claim 1, wherein the activity is associated with or comprises: a hardware change, a software change, a memory operation, a type of file accessed, a location of the file, a failed login attempt, user-interface activity, an executed application, or communication with another electronic device.

4. The electronic device of claim 1, wherein the pretrained predictive model comprises a neural network.

5. The electronic device of claim 1, wherein the pretrained predictive model is associated with multiple electronic devices previously used by the user.

6. The electronic device of claim 5, wherein the multiple electronic devices comprise the electronic device.

7. The electronic device of claim 1, wherein the pretrained predictive model is associated with different types of activities or personas of the user.

8. The electronic device of claim 1, wherein the pretrained predictive model is based at least in part on historical behavior of the user.

9. The electronic device of claim 1, wherein the remedial action comprises discontinuing the process, which is associated with the event.

10. The electronic device of claim 1, wherein the remedial action comprises changing an alert level for the user; and
wherein the alert level corresponds to a deviation from expected behavior of the user.

11. The electronic device of claim 1, wherein the monitoring, the analysis, the providing of the event information, the receiving of the severity information, and the selective performing of the remedial action occur in real-time as the electronic device performs the process, which is associated with the event.

12. The electronic device of claim 1, wherein, when the severity information indicates that the remedial action is not needed or that retraining is needed, the operations comprise updating the pretrained predictive model based at least in part on the event and the severity information.

13. The electronic device of claim 1, wherein, when the severity information indicates that the remedial action is not needed, the operations comprise providing, addressed to the computer system, feedback information for use in updating the pretrained predictive model; and
wherein the feedback information comprises the event information and the severity information.

14. The electronic device of claim 13, wherein the feedback information is provided after a current session of the user on the electronic device ends.

15. The electronic device of claim 1, wherein the event was not previously identified by the pretrained predictive model for the user.

16. A non-transitory computer-readable storage medium for use in conjunction with the electronic device, the computer-readable storage medium configured to store program instructions that, when executed by the electronic device, cause the electronic device to perform operations comprising:
receiving user information associated with a user of the electronic device;
providing, addressed to a computer system, the user information;
receiving, associated with the computer system, a pretrained predictive model associated with the user;
monitoring activity associated with an event while the user uses the electronic device, wherein the activity comprises a hardware activity, a software activity or both;
analyzing the activity using the pretrained predictive model to identify the event;
providing, addressed to the computer system, event information specifying a process, which is associated with the event;
receiving, associated with the computer system, severity information that indicates a security risk associated with the event; and
selectively performing a remedial action based at least in part on the severity information.

17. The non-transitory computer-readable storage medium of claim 16, wherein the pretrained predictive model is associated with multiple electronic devices previously used by the user.

18. A method for selectively performing a remedial action, comprising:
by an electronic device:
receiving user information associated with a user of the electronic device;
providing, addressed to a computer system, the user information;
receiving, associated with the computer system, a pretrained predictive model associated with the user;
monitoring activity associated with an event while the user uses the electronic device, wherein the activity comprises a hardware activity, a software activity or both;
analyzing the activity using the pretrained predictive model to identify the event;
providing, addressed to the computer system, event information specifying a process, which is associated with the event;
receiving, associated with the computer system, severity information that indicates a security risk associated with the event; and
selectively performing the remedial action based at least in part on the severity information.

19. The method of claim 18, wherein the pretrained predictive model is associated with multiple electronic devices previously used by the user.

20. The method of claim 18, wherein the event was not previously identified by the pretrained predictive model for the user.
